(19) United States
(12) Patent Application Publication
(10) Pub. No.: US 2005/0166646 A1
(43) Pub. Date: Aug. 4, 2005

(54) Method and apparatus for securing an object to a vehicle

(76) Inventor: Donald Alan Bistline, Vista, CA (US)

Correspondence Address: THOMAS M. THIBAULT, 11340 VISTA SORRENTO PARKWAY #306, SAN DIEGO, CA, 92130, US

(21) Appl. No.: 10/771,082

(22) Filed: Feb. 3, 2004

(51) Int. Cl. E05B 73/00

(52) U.S. Cl. 70/58

(57) ABSTRACT

A method and apparatus for securing an object to a vehicle comprises an adjustable shackle mounted to at least one extrusion, the extrusion comprising an adjustable retainer for securing the apparatus to a vehicle roof rack. The adjustable retainer provides an adjustable opening through which the vehicle roof rack may be positioned. The apparatus further comprises a position adjustment mechanism for moving at least a portion of the adjustable retainer and a locking mechanism for securing the adjustable retainer in a fixed position.

### BACKGROUND

1. Field of Use

The present invention relates to the field of theft prevention devices. More specifically, the present invention relates to a method and apparatus for securing an object, such as a surfboard, to a structure such as a motor vehicle.

2. Description of the Related Art

The sport of surfing has gained in popularity in the United States and abroad over the past several years. It is estimated that there are currently 3.5 million people who enjoy surfing in the United States alone. In most cases, surfboards are transported to the ocean on top of a car via roof racks or in the bed of a pickup truck. The typical method of securing surfboards to car top roof racks is by a canvas or rubber straps.

One of the disadvantages of transporting surfboards via motor vehicle is that few vehicles are large enough to transport surfboards inside. Consequently, most people transport surfboards external to their vehicles. There exists removable or permanent roof-top racks for automobiles whereby one or more surfboards can be secured for transport. Individuals owning pickup trucks can simply place their surfboard(s) in the bed of the pickup truck.

One disadvantage of transporting large objects such as surfboards external to a vehicle is that they are highly visible and therefore attract thieves when an owner leaves the surfboard unattended. These large objects are difficult to secure against theft due to their large size and unibody construction. Most roof racks today do not have a way to lock the surfboard securely to the vehicle. In most cases, elastic straps are all that is used to secure the surfboard to the vehicle. These are quickly and easily removed by thieves.

Most available surfboard locking mechanisms use a steel cable that is attached to a “leash plug” in the surfboard. The other end of the cable is then secured to a structure on the vehicle using a padlock or the like. These systems are generally easy for thieves to defeat, because the steel cable can be cut quickly with bolt cutters, or the leash plug can be destroyed.

A locking mechanism that does not rely on steel cables is described in a patent issued to Bolich (U.S. Pat. No. 5,582,044). In this patent, a surfboard is secured to the top of two roof racks using four independent locking mechanisms located at four edges of the surfboard. However, this device requires four elaborate locking mechanisms, which may be expensive to build and to purchase. Another drawback of this mechanism is that the surfboard may be easily removed if only one of the four locking mechanisms is defeated. Yet another drawback is that it is time consuming to lock and unlock the surfboard using four separate locking mechanisms.

Another locking mechanism that does not rely on steel cables is described a PCT publication entitled “Surfboard Security Locking System” to Spry (WO01/60660). In this publication, a locking device is described that secures a surfboard to a car roof rack using an adjustable, U-shaped locking mechanism. Half of the locking mechanism is fixedly secured to a vehicle roof rack, while the other half is removable. A major drawback of this invention is that half of the U-shaped locking mechanism remains secured to the vehicle, even when a surfboard is not being transported. This results in added wind resistance to the vehicle, and also degrades the look and styling of the vehicle.

What is needed is a theft prevention device for use with a vehicle that is easy to remove and install, while providing a high degree of security to objects being secured therein.

### SUMMARY

A method and apparatus for securing an object to a vehicle. In one embodiment, an apparatus for securing an object to a vehicle comprises an adjustable shackle mounted to at least one extrusion, the extrusion comprising an adjustable retainer for securing the apparatus to a vehicle roof rack. The adjustable retainer provides an adjustable opening through which said vehicle roof rack may be positioned. The apparatus further comprises a position adjustment mechanism for moving at least a portion of the adjustable retainer and a locking mechanism for securing the adjustable retainer in a fixed position.

In another embodiment, an apparatus for securing an object to a vehicle comprises

means for securing the object to at least one extrusion, the extrusion comprising means for capturing a vehicle roof rack, the means for providing an adjustable opening through which said vehicle roof rack may be positioned. The apparatus further comprises means for moving at least a portion of the means for capturing the vehicle roof rack and means for securing the means for capturing the vehicle roof rack in a fixed position.

In another embodiment, a method for securing an object to a vehicle comprises placing the vehicle roof rack within an adjustable retainer of a theft-prevention device, adjusting the adjustable retainer until the vehicle roof rack is captured therein, and securing the object through an adjustable shackle of the theft-prevention device.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1a illustrates an exploded view of one embodiment of a theft prevention device for securing an object to a vehicle;

FIG. 1b illustrates the theft-prevention device of FIG. 1a, shown from a side view;

FIGS. 2a through 2d illustrate various embodiments of an adjustable retainer as used in the theft-prevention device of FIGS. 1a and 1b;

FIG. 3 illustrates another embodiment of a theft-prevention device comprising a push lever/cam arrangement;

FIG. 4 illustrates a mid-wall used in the theft-prevention device of FIG. 3;

FIG. 5 illustrates a side view of the theft-prevention device of FIG. 3, with a second section of an adjustable retainer pushed a maximum distance toward a first section of the adjustable retainer;

FIG. 6 illustrates a theft prevention device closely resembling the theft-prevention device shown in FIGS. 1a and 1b, with the exception that the locking mechanism shown in FIGS. 1a and 1b comprises a simple shear pin;

FIG. 7 illustrates another embodiment for a theft-prevention device;

FIG. 8 illustrates the theft-prevention device of FIG. 7 in an unlocked position;

FIG. 9 is yet another embodiment of a theft-prevention device;

FIG. 10 is yet another embodiment of a theft-prevention device; and

FIG. 11 is a flow diagram illustrating a method for securing an object, such as a surfboard, to a vehicle.

### DETAILED DESCRIPTION

The methods and apparatus for securing an object to a vehicle detailed herein enable one to quickly and easily secure a surfboard to a vehicle roof rack to prevent theft. However, it should be understood that other types of articles could be secured in the alternative, such as snow skis, water skis, wakeboards, snowboards, etc. The described embodiments additionally allow the apparatus to be quickly installed and removed, without requiring any hardware to be permanently installed on the roof rack or vehicle itself.

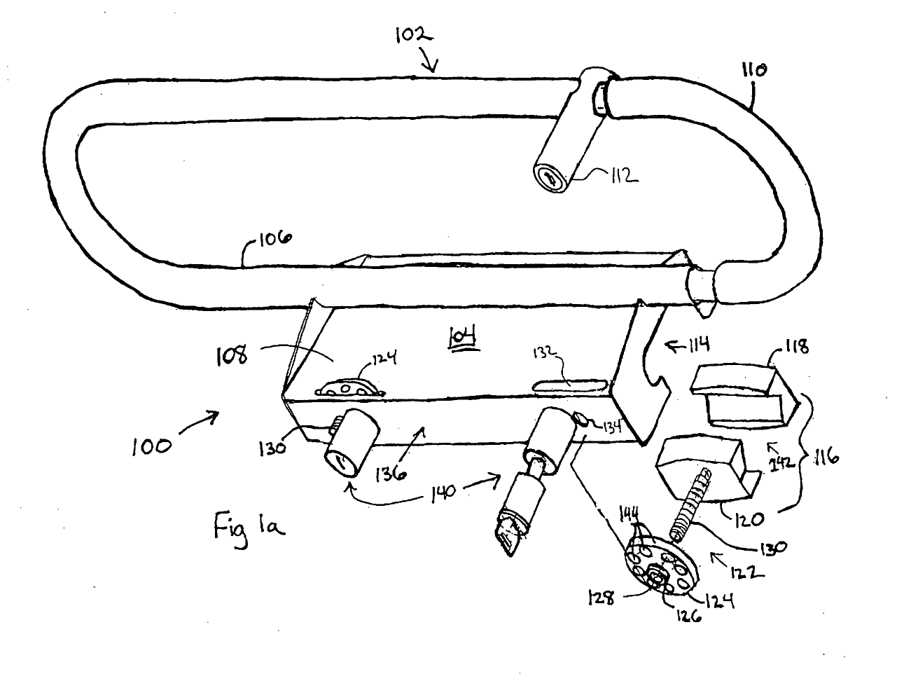

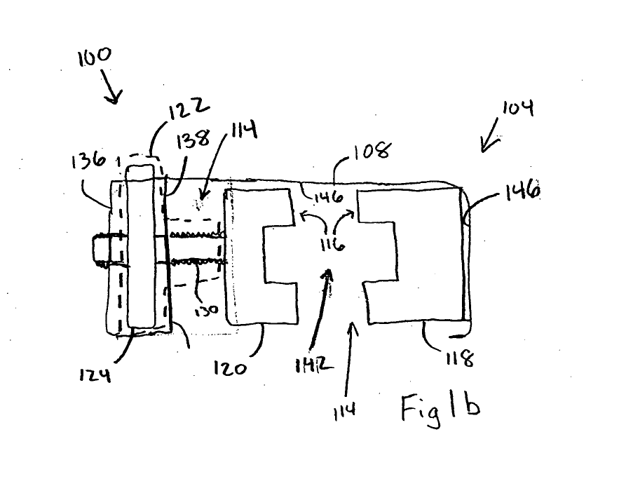

FIG. 1a illustrates one embodiment of a theft-prevention device 100 for securing an object to a vehicle roof rack, shown in an exploded view. FIG. 1b illustrates theft-prevention device 100, shown from a side view, without an adjustable shackle 102 for purposes of clarity. Such roof racks are commonly used to secure objects, such a surfboards, to a vehicle, typically using elastic straps, and are manufactured by companies such as Thule and Yakima. These roof racks are sold as after-market products and are attached to the vehicle by a consumer. Other roof racks are provided by automobile manufacturers, already permanently installed on the roof of vehicles.

The theft-prevention device 100 comprises a locking, adjustable shackle 102, that is permanently affixed to one or more extrusions 104. FIG. 1 illustrates an embodiment where only one extrusion is used, however, in other embodiments, the extrusion 104 may comprise two or more individual sections, each section generally able to be mounted to a vehicle roof rack as explained below.

The theft-prevention device 100 is designed to be completely removable from the vehicle roof rack when theft-prevention device 100 is not in use. Objects such as surfboards, skis, wakeboards, and snowboards are retained within adjustable shackle 102 by their respective physical properties such as board contour, fin(s), bindings, etc.

A fixed portion 106 of adjustable shackle 102 is generally permanently secured to a top surface 108 of extrusion 104, typically by welding or other suitable methods known in the art. An adjustable portion 110 of adjustable shackle 102 inserts into fixed portion 106, thereby forming an adjustable opening through which a surfboard, or other object, may be secured.

Both adjustable portion 110 and fixed portion 106 are preferably formed of a material not easily cut through with a hacksaw, for instance. The outer surface of each portion may additionally be covered with a hard plastic, rubber, or other material to add difficulty to anyone attempting to cut through either portion. Alternatively, or in addition to the hard material, padding may be deposited on fixed portion 106 and a portion of adjustable portion 110 so that minimal damage that might otherwise occur to an object that is secured by adjustable shackle 102.

Adjustable shackle 102 further comprises a locking mechanism 112, comprising a combination or key-operated lock, similar to many locking devices in common use today. Examples of manufacturers offering such a locking mechanism include ABA locks (www.abalocks.com) and Royal Lock Corporation of Wauconda, Ill. Locking mechanism 112 typically comprises a spring-loaded deadbolt which engages a series of notches located on adjustable portion 110. In an unlocked position, the deadbolt is pushed into a shank portion of locking mechanism 112 as each of the notches pass the deadbolt, thereby allowing free movement of adjustable portion 110 within fixed portion 106 and, thus, allowing an opening formed by adjustable shackle 102 to vary. In a locked position, the deadbolt is prevented from being pushed out of the notches, thereby preventing the opening formed by adjustable shackle 102 from varying.

Extrusion 104 comprises an elongated member having a channel 114 running through the length of extrusion 104. The channel houses various components of theft-prevention device 100, such as adjustable retainer 116, providing a space for a roof rack to pass. Extrusion 104 is generally manufactured from any rigid material, such as steal, aluminum, or any other rigid or semi-rigid material able to support adjustable shackle 102.

Adjustable retainer 116 is used to secure theft-prevention device 100 to a vehicle roof rack. In the embodiment of FIG. 1, two adjustable retainers are used, although a greater or lesser number of adjustable retainers could be used in other embodiments. The remainder of this disclosure will refer to the adjustable retainers 116, position adjustment mechanisms 122, and any holes in connection therewith, in the singular, since these features are identical on either end of extrusion 104 in this embodiment.

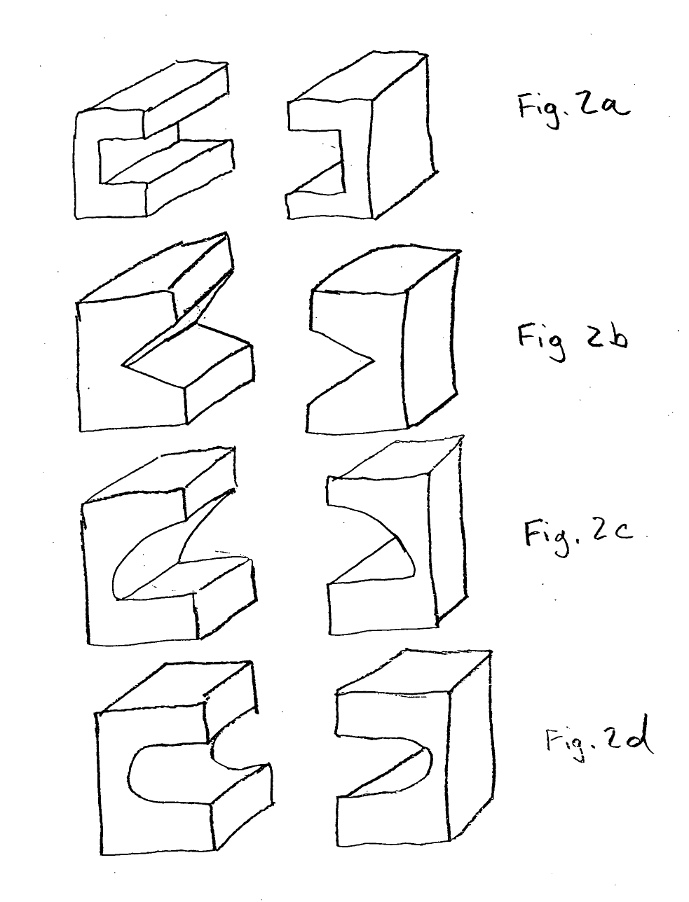

In general, adjustable retainer 116 is constructed of a material that is semi-rigid, such hard rubber, for example. The material is generally rigid enough to prevent adjustable retainer 116 from significantly deforming during a theft attempt, yet allows some flexibility so as to not damage a vehicle roof rack, and also to provide some compression of adjustable retainer 116 against the roof rack, thereby ensuring a snug fit. However, in other embodiments, adjustable retainer 116 could be constructed from any rigid material, such as metal, plastic, fiberglass, etc. As shown in FIG. 2a through 2d, adjustable retainer 116 may comprise a myriad of shapes and sizes to accommodate various roof rack cross sections. It should be understood that adjustable retainer 116 may comprise virtually any shape and dimensions, on both the concave and convex areas of adjustable retainer 116.

Adjustable retainer 116 provides an adjustable opening 142 through which the vehicle roof rack may be positioned. In this embodiment, adjustable retainer 116 comprises a first section 118 and a second section 120. The first section 118 is secured against an inside rear wall 146 (formed by channel 114) of the extrusion 104 and the second section 120 is connected to a position adjustment mechanism 122. First section 118 may additionally, or alternatively, be secured to a top inner wall 146 of extrusion 104, and/or a bottom inner wall of extrusion 104. Generally, first section 118 is fixedly mounted to the inside rear wall 144 while second section 120 is adjusted to and fro, thus varying the opening 142 formed by the first section 118 and second section 120.

Position adjustment mechanism 122 is used to move second section 120 with respect to first section 118. In the embodiment shown in FIG. 1, position adjustment mechanism 122 comprises an adjustment wheel 124 having a pair of collars 126 located on either side and at a center of the wheel 124. A hole 128 runs through the two collars 126 and adjustment wheel 124 for allowing a threaded rod 130 to pass. Hole 128 comprises threads through at least one of the collars 126 or adjustment wheel 124. One end of threaded rod 130 is connected to the second section 120 of adjustable retainer 116, while the other end is threaded through the threaded portion of hole 128.

Adjustment wheel 124 is held in place by slot 132 located on top surface 108, a hole 134 located on a front wall 136 of extrusion 104, and another hole (not shown) located on a mid-wall 138 and in alignment with hole 134, the mid-wall 138 located behind front wall 136. In one embodiment, hole 134 and the hole on mid-wall 138 each have a diameter smaller than the diameter of collars 126. In this case, the collars 126 abut these two holes, while threaded rod 130 contains adjustment wheel 124 in proper orientation relative to holes 134 and the hole in mid-wall 138. In another embodiment, hole 134 and the hole on mid-wall 138 each have a diameter approximating the diameter of collars 126 such that each collar fits within a respective one of the holes and allows adjustment wheel 124 to rotate. Slot 132 allows a portion of adjustment wheel 124 to protrude when adjustment wheel 124 is positioned in place. This protrusion allows a user to rotate adjustment wheel 124 in order to move second section 120 fore and aft.

When assembled, position adjustment mechanism 122 is used to adjust second section 120 so that theft prevention device 100 can be installed and removed from a vehicle roof rack. During installation, adjustment wheel 124 is rotated, either clockwise or counterclockwise, depending on the thread orientation of the threads on threaded rod 130 and threaded hole 128. The rotation of adjustment wheel 124 cause threaded hole 128 to act on threaded rod 130, causing threaded rod 130 to move perpendicularly with respect to adjustment wheel 124, in a direction which causes second section 120 to move away from first section 118, thereby enlarging opening 142. The adjustment wheel 124 is rotated a sufficient amount until opening 142 is large enough to allow theft-prevention device 100 to be installed over a vehicle roof rack. In this position, the vehicle roof rack lies loosely through opening 142.

Next, position adjustment mechanism 122 is adjusted to secure the adjustable retainer 116 around the roof rack. In the embodiment of FIG. 1, this is accomplished by turning adjustable wheel 124 in a direction opposite to the direction that caused opening 142 to enlarge. As adjustable wheel 124 is rotated, the threaded rod 130, and thus second section 120, associated with adjustable wheel 124 move in a direction towards first section 118. This results in opening 142 being reduced in size until an inside surface of adjustable retainer 116 comes in contact with the roof rack, thus capturing the roof rack. The adjustable wheel 124 may continue to be turned a bit further so that the adjustable retainer 116 is snug against the roof rack.

Next, a locking mechanism 140 is placed in a locked position, preventing adjustment wheel 124 from rotating. In the embodiment shown in FIG. 1, locking mechanism 140 comprises a plunger-type lock, which comprises a rigid pin that protrudes from the lock while in the locked position. The lock is mounted to front wall 136 over a hole in front wall 136 (not shown) that allows the pin to extend through. This hole is located such that it aligns with one of a number of holes 144 located around a perimeter of adjustable wheel 124. When the plunger-type lock is in the locked position, the pin extends through the hole in front wall 136 and then through one of the number of holes 144 on adjustable wheel 124. The pin may continue to extend through another hole in mid-wall 138 (not shown) that is aligned with one of the number of holes 144 and the hole over which the plunger-lock is located.

Of course, it is necessary to rotate adjustable wheel 124 so that one of the holes 144 align with the pin of the plunger-lock. This is generally accomplished while retaining a snug fit of adjustable retainer 116 against the roof rack, as it is not necessary to rotate adjustable wheel 124 much, even in a worse-case scenario. Once the pin is extended through one of the holes 144 and the hole in mid-wall 138 by virtue of the plunger-type lock being locked, adjustable wheel 124 is prevented from rotating, thus preventing adjustable retainer 116 from opening, and therefore securing the roof rack within adjustable retainer 116. Consequently, theft-prevention device 100 is secured to the roof rack.

Once theft-prevention device 100 is secured to the roof rack, an object such as a surfboard, may be placed within adjustable shackle 102, thereby securing the object to the vehicle. Removal of theft-prevention device 100 comprises reversing the just-described process for installing the device.

It should be understood that a variety of embodiments are possible other than what has been discussed thus far. The following describe several examples of various alternative embodiments.

In one alternative embodiment, first section 118 is not used. Instead inner rear wall 146 is shaped to accommodate approximately half the contour of a roof rack.

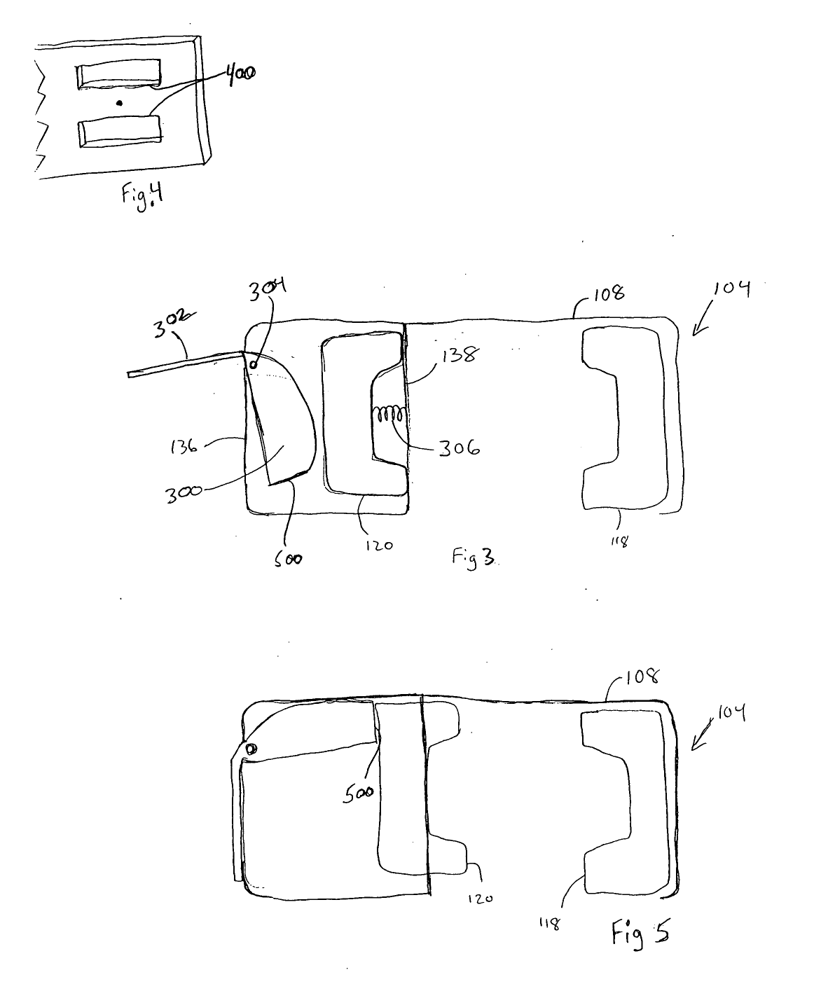

In another embodiment, position adjustment mechanism 122 comprises a push lever/cam arrangement, as shown in FIG. 3. FIG. 3 illustrates this embodiment as viewing extrusion 104 from a side view. In this embodiment, cam 300 is used to push second section 120 toward first section 118 during installation of theft-prevention device 100. In this embodiment, the locking mechanism comprises simply a flat surface 500 located on cam 300. However, it is recommended that theft-prevention device 100 be removed from the vehicle roof rack when not securing an object, as theft-prevention device 100 is susceptible of being stolen by simply by lifting lever 302 and removing theft-prevention device 100 from the roof rack. When an object is secured within theft-prevention device 100, lever 302 is generally inaccessible to thieves, because the object covers lever 302, making it inaccessible. Only removal of the object by way of locking mechanism 112 will allow one to access lever 302 to remove theft-prevention device 100.

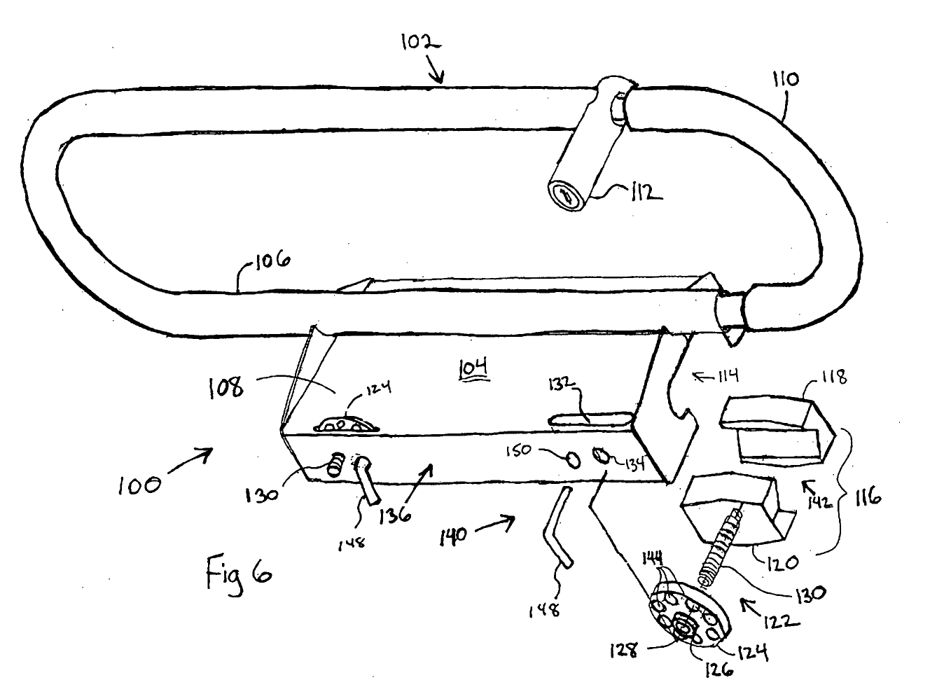

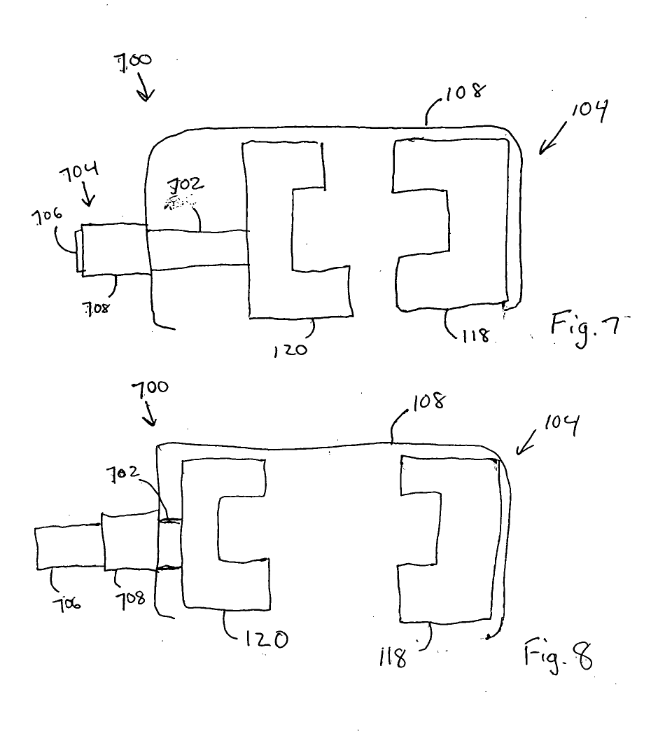

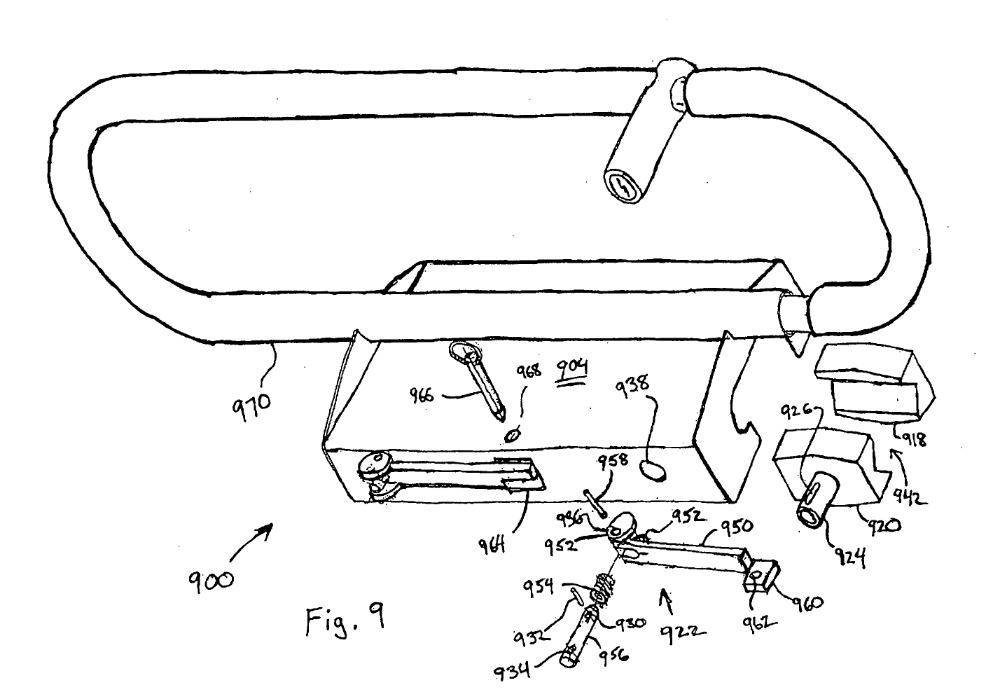

Cam 300 comprises lever 302 which is pushed by a user to move second section 120. In FIG. 3, cam 300/lever 302 is in a position that allows theft-prevention device 100 to be installed over a roof rack. A spring 306 is used to ensure that second section 120 is fully retracted, away from first section 118. The roof rack is placed within the confines of first section 118 and mid-wall 138. A user then pushes down on lever 302, causing cam 300 to pivot about retainer 304, which comprises a pin mounted to front wall 136. As the lever is pushed down and cam 300 rotated, which in turn acts on second section 120, forcing it toward first section 118. Second section 120 protrudes through mid-wall 138 through two rectangular openings 400, as shown in FIG. 4. FIG. 4 illustrates mid-wall 138, viewed in a direction looking toward first section 118.

FIG. 5 illustrates the embodiment shown in FIG. 3 with second section 120 pushed a maximum distance toward first section 118. In this figure, a user has pushed lever 302 down completely, extending second section 120 as far as possible. In this position, second section 120 protrudes through rectangular openings 400 and captures a roof rack between itself and first section 118. Lever 302/cam 300/second section 120 remain in place due to flat surface 500 on cam 300.

Another embodiment of a theft prevention device closely resembles the embodiment shown in FIG. 1, with the exception that the locking mechanism(s) 140 comprise a simple shear pin. This embodiment is shown in FIG. 6. Shear pin 148 is used to extend through a hole 150 in front wall 136. Hole 150 is equivalent to the hole hidden by locking mechanism 140 in the embodiment of FIG. 1. Shear pin 148, like the pin of locking mechanism 140, extends through hole 150, through one of the holes 144 in adjustment wheel 124, and through a hole in mid-wall 138 aligned with hole 150, if present. This secures adjustment wheel 124 in place, preventing second section 120 from moving, and therefore, preventing theft-prevention device 100 from being removed from the roof rack. As with the embodiment shown in FIG. 3, it is recommended that theft-prevention device 100 be removed from the vehicle roof rack when not securing an object, as theft-prevention device 100 is susceptible of being stolen by simply removing the shear pin, turning adjustment wheel 124 to loosen second section 120, and removing theft-prevention device 100 from the roof rack. When an object is secured within theft-prevention device 100, the shear pin is generally inaccessible to thieves, because the object covers the shear pin, making it inaccessible. Only removal of the object by way of locking mechanism 112 will allow one to access the shear pin to remove theft-prevention device 100.

FIG. 7 illustrates another embodiment for a theft-prevention device, shown as theft-prevention device 700. In this embodiment, adjustable wheel 124 is not used to position adjustable retainer 116. Rather, second section 120 of adjustable retainer 116 is moved by a pin 702 protruding from locking mechanism 704, which comprises a plunger-type locking device, similar to locking mechanism 140 as shown in FIG. 1. Theft-prevention device 700 is shown in a locked position, with plunger 706 pushed into casing 708 and locked in place by a key (not shown). Pushing plunger 706 into casing 708 extends pin 702, and therefore second section 120, toward first section 118. FIG. 8 illustrates theft-prevention device 700 in an unlocked position. In this illustration, plunger 706 has been released from casing 708 by operation of a key on plunger 706. As such, plunger 706 protrudes from casing 708, generally by means of a spring inside casing 708, a distance generally equal to the length of casing 708, although plunger 706 could protrude a lesser or greater distance from casing 708 in other embodiments. As a result of plunger 706 moving from the locked to the unlocked position, pin 702 and second section 120 are moved in tandem with plunger 706, thereby enlarging opening 142 and allowing theft-prevention device 700 to be removed from a vehicle roof rack.

FIG. 9 is yet another embodiment of a theft-prevention device, shown as theft-prevention device 900. In this embodiment, position adjustment mechanism 122 comprises a folding cam lever assembly 922 on either end of extrusion 904. The assembly 922 is used to push second section 920 toward first section 918 during installation of theft-prevention device 900, thereby reducing opening 942 for a snug fit around a vehicle roof rack. The assembly 922 is also used to pull second section 920 away from first section 918 during removal of theft-prevention device 900.

Assembly 922 comprises lever 950, two cams 952, spring 954, push rod 956, and pin 958. Push rod 956 inserts partially into spring 954 and spring 954 is inserted into a tube 924 that is joined to second section 920. Tube 924 comprises a slot which aligns with a hole 930 in push rod 956. Once aligned, a pin 932 is inserted through slot 926 and into hole 930, where it is secured by compression or by some other physical mechanism, such as glue, welding, or threads. The pin 932 extends through slot 926 while it is secured into push rod 956.

Push rod 956 further comprises a second hole 934 located at an opposite end of push rod 956 from hole 930. Lever 950 is connected to push rod 956 by inserting the end of push rod 956 (having hole 934) through hole 938 in extrusion 904 from “inside” extrusion 904. Holes 936 in cams 952 are then aligned with hole 934, and pin 958 is inserted through holes 936 and 934, thereby pivotally connecting lever 950 to push rod 956 through hole 938. Holes 936 on cams 952 are located near an edge of cams 952 to provide a maximum distance for push rod 956 to travel as lever 950 is pivoted toward the center of extrusion 904.

To use theft-prevention device 900, both levers 950 are pivoted in a plane parallel to the bottom of extrusion 904, so that each lever extends past a respective end of extrusion 904. The positioning of levers 950 in this state act to rotate holes 936 away extrusion 904, causing push pin 956 to move away first section 918, thereby causing opening 942 to increase in size. This allows a vehicle roof rack to be loosely placed within first section 918 and second section 920. Once the roof rack is placed within first section 918 and second section 920, the levers 950 are rotated towards the center of extrusion 904, again in a plane parallel to the bottom of extrusion 904. This causes holes 936 to rotate towards extrusion 904, causing push rod 956 to act upon second section 920, to move second section 920 towards first section 918, thus securely capturing the vehicle roof between first section 918 and second section 920.

The end of lever 950 comprises a latch 960, comprising a hole 962. When each lever 950 is positioned so that the roof rack is securely captured by first section 918 and second section 920, the latch 960 on each lever 950 overlap and extend into a square cutout 964 in extrusion 904. When both latches are inside of cutout 964, a retaining pin 966 is dropped through a hole 968 on extrusion 904 and through both holes 962 in latches 960. Retaining pin 966 prevents levers 950 from being moved and, consequently, prevents second section 920 from moving, thereby securing theft-prevention device 900 to the vehicle roof rack. When an object is secured through adjustable shackle 970, retaining pin 966 is generally inaccessible due to the object covering retaining pin 966. In this embodiment, then, a key or combination lock is not required for theft-prevention device 900 to remain securely fastened to a vehicle roof rack, as long as an object is secured through adjustable shackle 970.

Various alternative embodiments of theft-prevention device 900 are possible. For example, a lock could be used in place of retaining pin 966, such as a plunger-type lock as shown in FIG. 1. The plunger lock could be mounted above hole 968 so that when the two latches 960 are aligned within cutout 964, a user can lock levers 950 in place by pushing down on the plunger lock, thereby inserting a pin housed by the lock into holes 962. The lock may then be placed in a locked position, either by a key or combination, thereby securing the levers 950 in place. In this embodiment, theft-prevention device 900 may be left secured to a vehicle roof rack even without having an object secured through adjustable shackle 970, because this design does not rely on an object obscuring access to the levers 950 to prevent unauthorized removal of theft-prevention device 900.

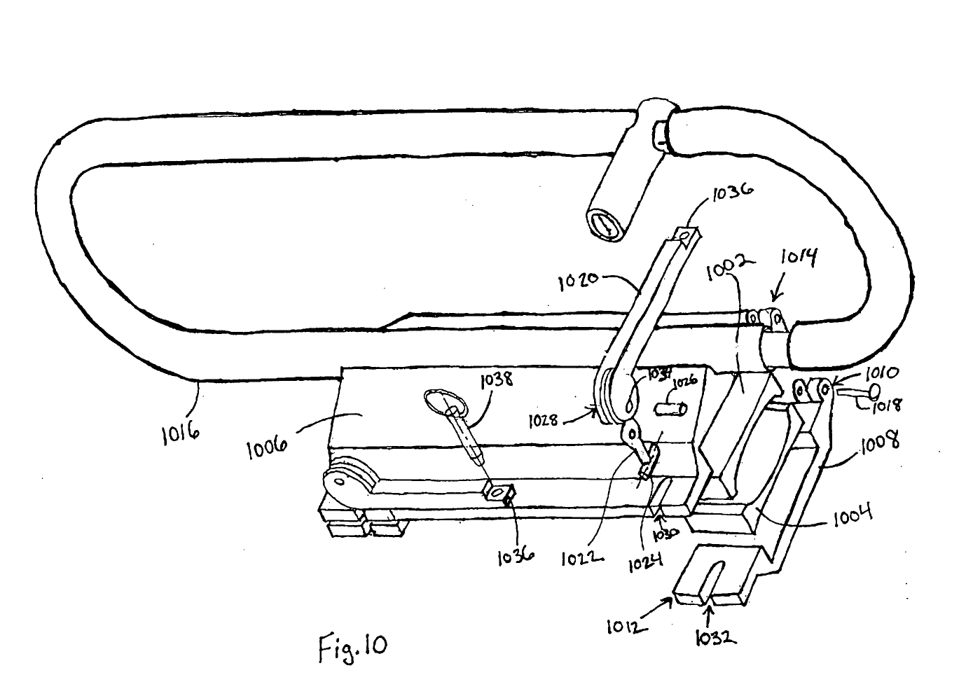

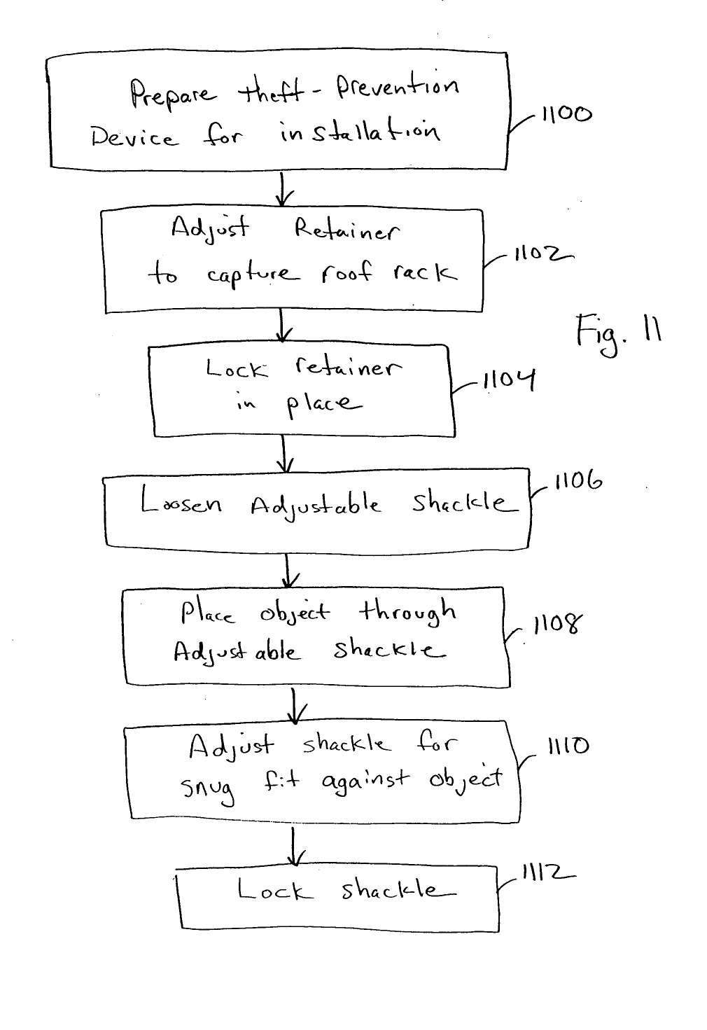

FIG. 10 is yet another embodiment of a theft-prevention device, shown as theft-prevention device 1000. In this embodiment, adjustable retainer(s) comprise upper section 1002 and lower section 1004 that surrounds a roof rack from the top and bottom when theft-prevention device 1000 is installed. Upper section 1002 and lower section 1004 are similar to first section 118 and second section 120 of FIGS. 1a and 1b, except that they are designed to surround a roof rack from the top and bottom. Upper section 1002 and lower section 1004 comprise a concave surface which approximates the particular cross-sectional shape of a roof rack. As the case with adjustable retainer 116, both the concave and convex surfaces of upper section 1002 and lower section 1004 may comprise a myriad of sizes and shapes to fit a variety of different roof racks. Also, upper section 1002 and lower section 1004 may be manufactured from a semi-rigid material similar to adjustable retainer 116, or from any rigid material.

Upper section 1002 is held within a channel of extrusion 1006. The channel may extend the entire length of extrusion 1006, or it may be limited to only the area near the end of extrusion 1006. Lower section 1004 is held within another channel of hinged clamp 1008, again either extending the entire length of hinged clamp 1008 or limited to only the area near the end of hinged clamp 1008.

Extrusion 1006 comprises a length of solid, rigid material such as any type of metal, hard plastic, or the like. Hinged clamp 1008 comprises a length of rigid material like extrusion 1006, having a hinged end 1010 and a slotted end 1012. In the embodiment of FIG. 10, two such hinged clamps 1008 are used, one at either end of extrusion 1006. In other embodiments hinged clamp could comprise a single unit, running the entire length, or only a portion of, extrusion 1006. In another embodiment, theft-prevention device 1000 comprises a single hinged clamp 1008 having a width approximate to that shown in FIG. 10, and located near the center of extrusion 1006. In yet another embodiment, hinged clamp 1008 comprises a single structure having a length approximately equal to the length of extrusion 1006 in FIG. 10, however extrusion 1006 comprises two, individual sections proximate each end of hinged clamp 1008, with each section mounted to adjustable shackle 1016. In this embodiment, extrusions 1006 have approximately the same width as hinged clamp 1008 in FIG. 10. In any of these embodiments, upper section 1002 and lower section 1004 may conform to the length of extrusion 1006, the width of hinged clamp 1008, or comprise a width unrelated to either extrusion 1006 or hinged clamp 1008.

In the embodiment shown in FIG. 10, upper section 1002 is held into the channel of extrusion 1006 while lower section 1004 is held into the channel of hinged clamp 1008. It should be understood that while the embodiment of FIG. 10 illustrates two hinged clamps 1008, two upper sections 1002, two lower sections 1004 (most of the second hinged clamp 1008, upper section 1002, and lower section 1004 shown in an assembled state at the left end of extrusion 1006), and associated hardware, the remaining discussion of this embodiment will refer to these items in the singular. All discussion of these features in the exploded view of FIG. 10 will apply to the assembled features at the left of extrusion 1006.

Hinged end 1010 is aligned with a hinged end 1014 of extrusion 1006 during the manufacturing process and the two are held together by a pin 1018, which could alternatively comprise a dowel, rivet, screw, bolt, or the like. At this point, hinged clamp 1008 pivots about the union of hinged end 1010 and hinged end 1014.

Upon installation of theft-prevention device 1000 to a vehicle roof rack, hinged clamp 1008 is opened an amount that allows the roof rack to slide between upper section 1002 and lower section 1004. Next, slotted end 1012 of hinged clamp 1008 is pivoted toward extrusion 1006, thereby clamping the roof rack securely between upper section 1002 and lower section 1004. A locking mechanism is used to secure hinged clamp 1008 in this position, the locking mechanism comprising a latch 1020, rod 1022, securing rod 1024, and pin 1026. The securing rod is securely mounted perpendicularly to rod 1022 as shown, then rod 1022 is pinned into a slotted end 1028 of latch 1020 using pin 1026. These components are generally permanently assembled to one another.

To secure hinged clamp 1008 to extrusion 1006, securing rod 1024 is placed in an orientation matching slot 1030 on extrusion 1006 and slot 1032 on hinged clamp 1008. Securing rod is lowered through both slots, protruding completely through slot 1032. Latch 1020 is then rotated approximately ninety degrees clockwise (counter-clockwise for latch 1020 on the left side of extrusion 1006) in a plane parallel to a roof of the vehicle to which theft-prevention device 1000 is being installed. This positions securing rod perpendicular to slot 1032, preventing its removal from slot 1032 and also binding hinged clamp 1008 loosely to extrusion 1006.

Latch 1020 is then rotated counter-clockwise (clockwise for latch 1020 on the left side of extrusion 1006) one hundred eighty degrees in a plane perpendicular to the vehicle roof, ultimately coming to rest on extrusion 1006. The rotation of latch 1020 during this step creates an upward force on rod 1022 and securing rod 1024 due to the non-concentric placement of hole 1034 in slotted end 1028. The force clamps hinged clamp 1008 tightly to extrusion 1006, thereby clamping the vehicle roof rack securely between upper section 1002 and lower section 1004. When both latches 1020 are in this position, an overlap occurs at their respective ends 1036. Each end 1036 comprises a cut-away section and a through hole. The holes overlap, allowing a pin 1038 to be inserted through the two holes and through a hole in extrusion 1006 (not shown). Pin 1038 helps prevent either latch from lifting away from extrusion 1006, thereby ensuring that theft-prevention device 1000 remains securely fastened to the vehicle roof rack. When an object is secured through adjustable shackle 1016, pin 1038 is generally inaccessible due to the object covering pin 1038. In this embodiment, then, a key or combination lock is not required for theft-prevention device 1000 to remain securely fastened to a vehicle roof rack, as long as an object is secured through adjustable shackle 1016.

Various alternative embodiments of fastening and securing hinged clamp 1008 to extrusion 1006 are possible. For example, the two latch assemblies shown in FIG. 10 could be replaced by a single, two, or more, key or combination locks. In this embodiment, a lock having a rotatable protrusion similar to rod 1022 and securing rod 1024 is secured to extrusion 1006. Theft-prevention device 1000 is installed loosely onto a vehicle roof rack as before, and slotted end 1032 is pushed toward extrusion 1006, securing the roof rack within upper section 1002 and lower section 1004. In this position, the rotatable protrusion of the lock extends just past slot 1032. Then, the lock is placed into the locked position, which rotates the protrusion so that the securing rod is perpendicular to slot 1032, thereby preventing its removal through slot 1032. This locks theft-prevention device 1000 to the vehicle roof rack.

FIG. 11 is a flow diagram illustrating a method for securing an object, such as a surfboard, to a vehicle. The method is applicable to all of the various embodiments discussed herein.

In step 1100, a theft-prevention device is prepped for installation onto a vehicle roof rack. This entails adjusting opening 142, using position adjustment mechanism 122, an amount that will allow adjustable retainer 116 to be placed over a vehicle roof rack. Generally, an object to be secured by theft-prevention device is not installed at this time.

Next, in step 1102, adjustable retainer 116 is adjusted using position adjustment mechanism 122 so that the vehicle roof rack is captured within adjustable retainer 116.

In step 1104, a locking mechanism is used to hold adjustable retainer 116 in place, in embodiments that use such a locking mechanism.

In step 1106, adjustable portion 110 of adjustable shackle 102 is moved if necessary to accommodate the object being secured. Locking mechanism 112 is generally placed in an unlocked position to allow movement of adjustable portion 110 during this step.

In step 1108, the object to be secured is placed through an opening formed by adjustable shackle 102. In the case of a surfboard, the surfboard is generally placed upside down with the fin(s) extending upward. The nose of the surfboard is then placed through the opening of adjustable shackle 102, a front portion of the surfboard resting on a standard roof rack securing system or a second theft-prevention device located on a forward roof rack. The surfboard is positioned forward until either its fin(s) touch adjustable shackle 102, or the width of the surfboard begins to narrow. Alternatively, adjustable portion 110 may be completely removed from fixed portion 106, thereby allowing the surfboard to be slid sideways into the opening formed by fixed portion 106.

In step 1110, adjustable portion 110 is moved relative to fixed portion 106, such that the opening formed by adjustable shackle 102 is reduced in size to fit snugly against opposing rails of the surfboard. In one embodiment, locking mechanism 112 may be in a locked or an unlock position during this step (i.e., the locking mechanism 112 in combination with notches on adjustable portion 110 forming a one-way ratchet).

In step 1112, locking mechanism 112 is placed into a locked position, generally by using a key. The surfboard is now securely fastened to the theft-prevention device.

Removal of the surfboard is a process reversed from the just-described process of FIG. 11.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

1. An apparatus for securing an object to a vehicle, comprising:
an adjustable shackle mounted to at least one extrusion;
the extrusion comprising:
an adjustable retainer for securing the apparatus to a vehicle roof rack, the adjustable retainer for providing an adjustable opening through which said vehicle roof rack may be positioned;
a position adjustment mechanism for moving at least a portion of the adjustable retainer; and
a locking mechanism for securing the adjustable retainer in a fixed position.

2. The apparatus of claim 1, wherein said adjustable retainer comprises a first section and a second section, the first section secured against an inside wall of the extrusion and the second section connected to the position adjustment mechanism.

3. The apparatus of claim 1, wherein the adjustable retainer comprises an concave surface that substantially conforms to a cross section of the vehicle roof rack.

4. The apparatus of claim 1, wherein the locking mechanism is inaccessible when the object is secured within the adjustable shackle.

5. The apparatus of claim 1 wherein the position adjustment mechanism comprises:
an adjustment wheel having a threaded hole located at a center of the disk;
a threaded rod having one end connected to the adjustable retainer means, the threaded rod screwed into the threaded hole;
and the extrusion further comprises:
a hole located on a front wall of the extrusion for allowing the rod to extend therethrough; and
a slot located on a top surface of the extrusion for allowing the circular disk to protrude.

6. The apparatus of claim 5, wherein:
the circular disk comprises a number of holes located around the perimeter of the disk;
the extrusion comprises a second hole located on the front wall the extrusion and located a distance from said hole such that the number of holes on the circular disk align with the second hole as the disk is rotated; and
the locking mechanism comprises a lock having an extendable pin which protrudes through the second hole and one of the number of holes located around the perimeter of the disk when the locking mechanism is in a locked position.

7. The apparatus of claim 5, wherein:
the circular disk comprises a number of holes located around the perimeter of the disk;
the extrusion comprises a second hole located on the front wall the extrusion and located a distance from said hole such that the number of holes on the circular disk align with the second hole as the disk is rotated; and
the locking mechanism comprises a shear pin.

8. The apparatus of claim 1 wherein:
the position adjustment mechanism comprises:
a cam;
a lever connected to the cam; and
a retainer positioned through the cam and for allowing the cam to rotate about the retainer;
and the locking mechanism comprises a flat surface located on the cam.

9. The apparatus of claim 1, wherein:
the position adjustment mechanism comprises a pin having a first end connected to a second section of the adjustable retainer and a second end connected to the locking mechanism; wherein
the locking mechanism comprises a plunger-type lock.

10. The apparatus of claim 1, wherein:
the position adjustment mechanism comprises a lever assembly connected to a second section of the adjustable retainer; and
the locking mechanism comprises a retaining pin for securing the lever assembly to the extrusion.

11. The apparatus of claim 1 wherein:
the position adjustment mechanism comprises a lever assembly connected to a second section of the adjustable retainer; and
the locking mechanism comprises a plunger-type lock for securing the lever assembly to the extrusion.

12. The apparatus of claim 1, wherein:
the position adjustment mechanism comprises:
a hinged clamp hinged to the extrusion;
a rotatable latch for clamping the hinged clamp to the extrusion; and
the locking mechanism comprises a retaining pin for securing the rotatable latch to the extrusion.

13. The apparatus of claim 1, wherein:
the position adjustment mechanism comprises:
a hinged clamp hinged to the extrusion;
a rotatable latch for clamping the hinged clamp to the extrusion; and
the locking mechanism comprises a plunger-type lock for securing the rotatable latch to the extrusion.

14. An apparatus for securing an object to a vehicle, comprising:
means for securing the object to at least one extrusion;
the extrusion comprising:
means for capturing a vehicle roof rack, the means for providing an adjustable opening through which said vehicle roof rack may be positioned;
means for moving at least a portion of the means for capturing the vehicle roof rack; and
means for securing the means for capturing the vehicle roof rack in a fixed position.

15. The apparatus of claim 14, wherein said means for capturing a vehicle roof rack comprises a first section and a second section, the first section secured against an inside wall of the extrusion, and the second section connected to the means for moving at least a portion of the means for capturing the vehicle roof rack.

16. The apparatus of claim 14, wherein the means for capturing the vehicle roof rack comprises a concave surface that substantially conforms to a cross section of the vehicle roof rack.

17. The apparatus of claim 14, wherein the means for securing the means for capturing the vehicle roof rack is inaccessible when the object is secured within the means for securing the object to at least one extrusion.

18. The apparatus of claim 14 wherein the means for moving at least a portion of the means for capturing the vehicle roof rack comprises:
a rod having one end connected to the means for capturing the vehicle roof rack; and
means for moving the rod;
and the extrusion further comprises:
a hole located on a front wall of the extrusion for allowing the rod to extend therethrough.

19. The apparatus of claim 14 wherein:
the means for moving the means for capturing the vehicle roof rack comprises:
means for pushing at least a portion of the means for capturing the vehicle roof rack.

20. The apparatus of claim 14, wherein:
the means for moving the means for capturing the vehicle roof rack comprises means for connecting at least a portion of the means for capturing the vehicle roof rack and the means for securing the means for capturing the vehicle roof rack; wherein
the means for securing the means for capturing the vehicle roof rack comprises a plunger-type lock.

21. The apparatus of claim 14, wherein:
the means for moving the means for capturing the vehicle roof rack comprises a lever assembly connected to a portion of the means for capturing the vehicle roof rack; and
the means for securing the means for capturing the vehicle roof rack comprises a retaining pin for securing the lever assembly to the extrusion.

22. The apparatus of claim 14 wherein:
the means for moving the means for capturing the vehicle roof rack comprises a lever assembly connected to a portion of the means for capturing the vehicle roof rack; and
the means for securing the means for capturing the vehicle roof rack comprises a plunger-type lock for securing the lever assembly to the extrusion.

23. The apparatus of claim 14, wherein:
the means for moving the means for capturing the vehicle roof rack comprises hinged means for hingedly connecting to the extrusion; and
the means for securing the means for capturing the vehicle roof rack comprises means for securing the hinged means to the extrusion.

24. A method for securing an object to a vehicle roof rack, comprising:
placing the vehicle roof rack within an adjustable retainer of a theft-prevention device;
adjusting the adjustable retainer until the vehicle roof rack is captured therein; and
securing the object through an adjustable shackle of the theft-prevention device.

25. The method of claim 24 further comprising locking the adjustable retainer in place.
